(19) United States
(12) Patent Application Publication
(10) Pub. No.: US 2013/0243914 A1
(43) Pub. Date: Sep. 19, 2013

(54) Anhydrous Mix for a Food Product Coating

(71) Applicant: MP-OTHA CORPORATION, Galesburg, IL (US)

(72) Inventor: Ernest G. Markisich, North Salt Lake, UT (US)

(73) Assignee: MP-OTHA CORPORATION, Galesburg, IL (US)

(21) Appl. No.: 13/846,656

(22) Filed: Mar. 18, 2013

Related U.S. Application Data
(60) Provisional application No. 61/612,119, filed on Mar. 16, 2012.

(51) Int. Cl. A23G 3/34

(52) U.S. Cl. CPC A23G 3/343
USPC 426/250; 426/654; 426/650; 426/302

(57) ABSTRACT

Apparatuses, systems, and methods are disclosed for an anhydrous mix for a food product coating. A method includes providing one or more anhydrous sweeteners. A method includes providing an anhydrous stabilizer. A method includes mixing one or more anhydrous sweeteners and an anhydrous stabilizer to form an anhydrous mix for a food product coating.

### CROSS-REFERENCES TO RELATED APPLICATIONS

This application claims the benefit of U.S. Provisional Patent Application No. 61/612,119 entitled “ANHYDROUS MIX FOR A FOOD PRODUCT COATING” and filed on Mar. 16, 2012 for Ernest G. Markisich, which is incorporated herein by reference.

### FIELD OF THE INVENTION

This invention relates to coatings for food products and more particularly relates to glaze coatings for food products.

### BACKGROUND

A coating is often applied to a food product to impart a desired taste, texture, or look to the food product. For example, a coating of glaze, icing, or the like may be applied to a doughnut, pastry, cake, or other food product to give the food product a sweeter taste or a shinier look than the food product would have without the coating.

Before application to a food product, coatings for food products are typically liquids and have limited shelf lives. If the coating includes a milk product, the coating must be refrigerated before use and will eventually sour. Refrigeration also typically causes a coating to harden or set up, making the coating difficult to apply to a food product. Even if a coating does not include a milk product, the sugars in the coating can cause the coating to ferment, limiting the shelf life of the coating.

Preparation of a liquid coating for a food product can be a complicated multi-step process, so liquid coatings are typically shipped to end users in their final, liquid form. Due to the limited shelf life of typical liquid coatings, any shipment must occur promptly. The high liquid content of a liquid coating, in addition to the time constraints, can cause shipping prices to be substantial.

### SUMMARY

A need exists for an apparatus, system, and method that provide a food product coating with an extended shelf life. Beneficially, such an apparatus, system, and method would provide an anhydrous mix for a food product coating that weighs less than the food product coating itself.

The present invention has been developed in response to the present state of the art, and in particular, in response to the problems and needs in the art that have not yet been fully solved by currently available food product coatings. Accordingly, the present invention has been developed to provide an apparatus, system, and method for an anhydrous mix for a food product coating that overcome many or all of the above-discussed shortcomings in the art.

Methods for an anhydrous mix for a food product coating are presented. In one embodiment, a method includes providing one or more anhydrous sweeteners. In a further embodiment, a method includes providing an anhydrous stabilizer. A method, in one embodiment, includes mixing one or more anhydrous sweeteners and an anhydrous stabilizer to form an anhydrous mix for a food product coating.

In another embodiment, a method includes heating a liquid. A method, in one embodiment, includes introducing a liquid and an anhydrous mix. An anhydrous mix, in certain embodiments, comprises one or more anhydrous sweeteners and an anhydrous stabilizer. A liquid and an anhydrous mix, in one embodiment, are introduced without pre-hydration of an anhydrous stabilizer. A method, in a further embodiment, includes mixing an anhydrous mix and a liquid to form a food product coating.

Anhydrous mixes for a food product coating are presented. An anhydrous mix, in one embodiment, includes one or more anhydrous sweeteners. In a further embodiment, an anhydrous mix includes an anhydrous stabilizer. An anhydrous stabilizer, in certain embodiments, is configured to inhibit one or more anhydrous sweeteners from separating with a liquid when mixed with the liquid.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings, which depict only typical embodiments of the invention and are not to be considered to be limiting of its scope:

FIG. 1 is a perspective view illustrating one embodiment of a system for applying a liquid food product coating in accordance with the present invention;

FIG. 2 is a sectional view illustrating one embodiment of an anhydrous mix for a food product coating in accordance with the present invention;

FIG. 3A is a perspective view illustrating embodiments of stabilizers in accordance with the present invention;

FIG. 3B is a perspective view illustrating further embodiments of stabilizers in accordance with the present invention;

FIG. 4 is a schematic flowchart diagram illustrating one embodiment of a method for preparing an anhydrous mix for a food product coating in accordance with the present invention;

FIG. 5 is a schematic flowchart diagram illustrating another embodiment of a method for preparing an anhydrous mix for a food product coating in accordance with the present invention;

FIG. 6 is a schematic flowchart diagram illustrating one embodiment of a method for preparing a food product coating from an anhydrous mix in accordance with the present invention; and

FIG. 7 is a schematic flowchart diagram illustrating one embodiment of a method for applying a food product coating prepared from an anhydrous mix to food products in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps of each are indicative of one embodiment of the presented method. Other steps and methods may be conceived that are equivalent in function, logic, or effect to one or more steps, or portions thereof, of an illustrated method. Additionally, the format and symbols employed, such as the various arrow types and line types, are provided to explain the logical steps of the method and are understood not to limit the scope of the method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

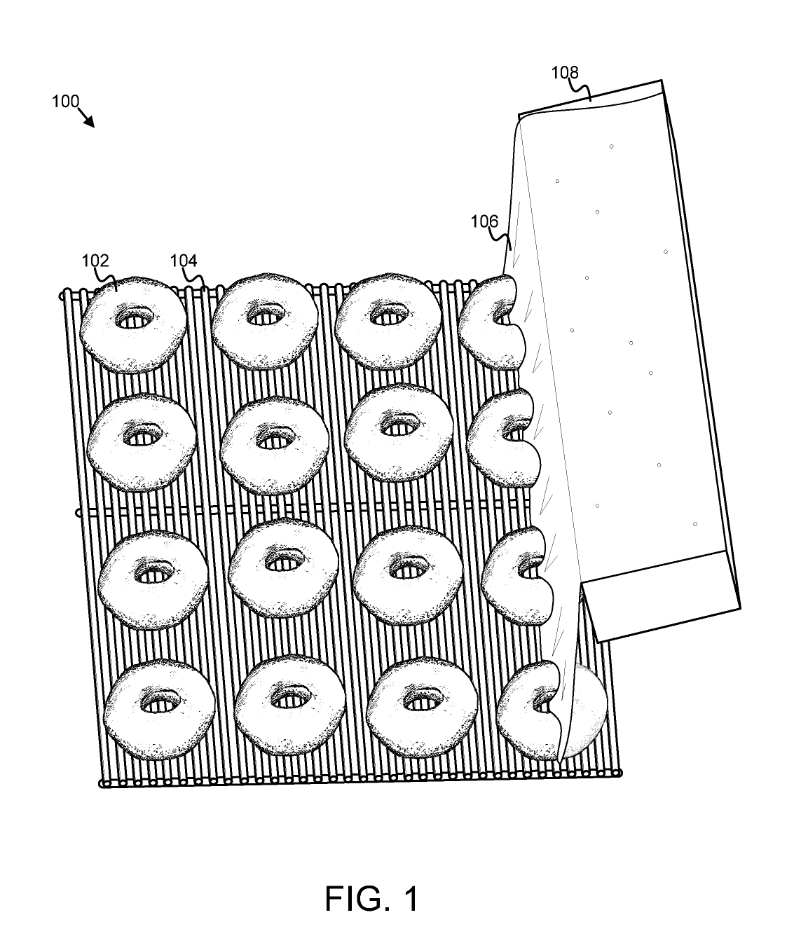

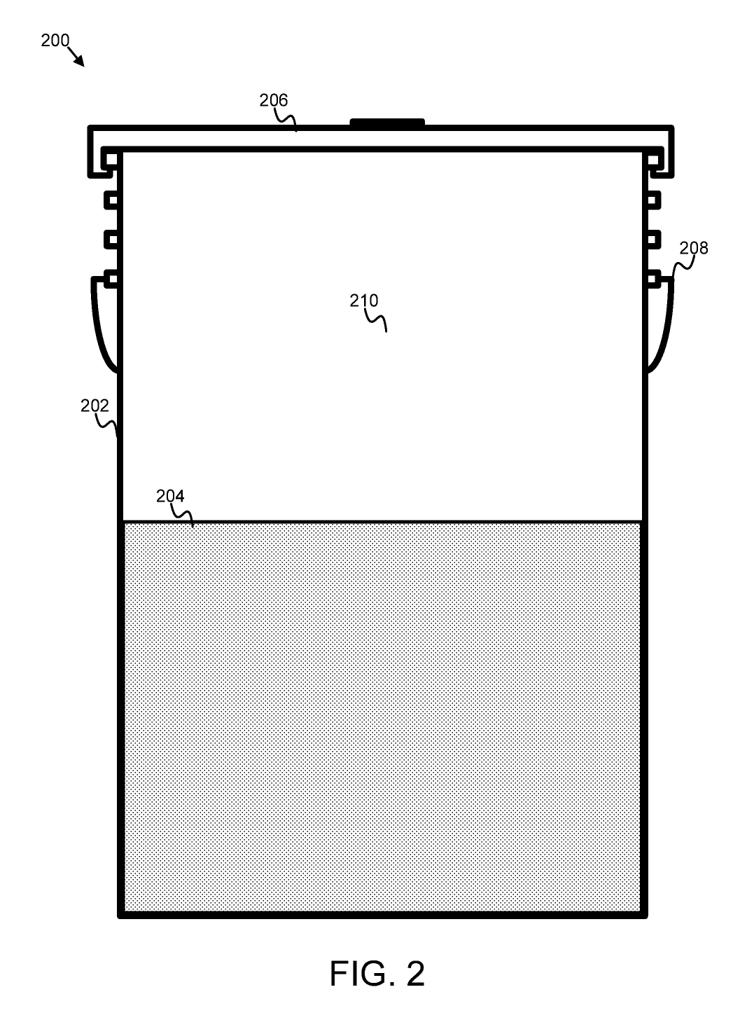

FIG. 1 depicts one embodiment of a system 100 for applying a food product coating 106 to food products 102. The food product coating 106, in the depicted embodiment, comprises a liquid prepared from an anhydrous mix, such as the anhydrous mix 204 described in greater detail below with regard to FIG. 2. The food product coating 106 may include a glaze, an icing, a topping, a frosting, or another coating applied to an outer surface of a food product 102. In the depicted embodiment, the food product coating 106 comprises a glaze or glaze icing applied to an outer surface of doughnut food products 102. Other food products also suitable for such coating include pastries, cakes, breads, rolls, and other bakery products. The food product coating may comprise an icing, frosting, or other topping. The glaze food product coating 106, prior to application, is typically fluid and has a thinner consistency than other coatings; for example, in one embodiment, the food product coating 106 may be a glaze with a pre-application viscosity of less than about 1 Pa·s, or the like, at least at certain temperatures.

The anhydrous mix 204 (FIG. 2) is a dry or substantially dry solid mixture with a plurality of ingredients. Depending on the particle size and/or other chemical properties of the anhydrous mix 204, the food product coating 106 may comprise a liquid mixture, a solution, a suspension, a colloid, or the like. By providing an anhydrous mix 204 to an end user, such as a bakery, a food product manufacturer, a restaurant, a doughnut shop, or the like, the end user may prepare the food product coating 106 from the anhydrous mix 204 onsite as needed. The anhydrous mix 204 associated with the food product coating 106 weighs less than the food product coating 106, and may therefore generally be shipped at a lower cost than shipping the food product coating 106.

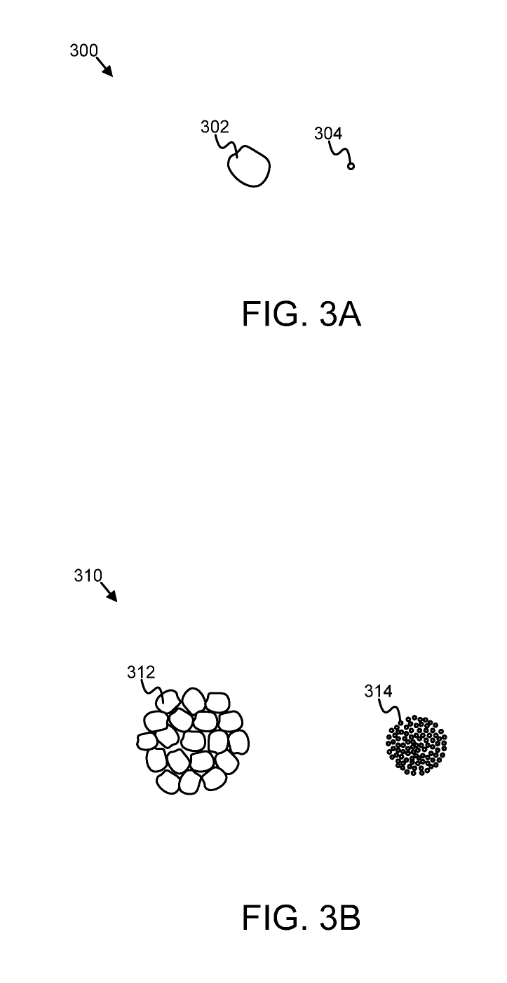

In certain embodiments, the anhydrous mix 204 includes a stabilizer, such as agar, described in greater detail below with regard to FIGS. 2, 3A, and 3B, with characteristics selected to allow an end user to add and/or mix the anhydrous mix 204 with water in a single step, without adding and/or mixing the stabilizer with water separately from other components of the anhydrous mix 204. A stabilizer, as used herein, inhibits separation of different components of the food product coating 106. In certain embodiments, a stabilizer may extend the shelf life of the food product coating 106 and other food product coatings, and of the food products 102 and other food products to which the food product coating 106 is applied. For example, a stabilizer may inhibit sugars or other ingredients from the anhydrous mix 204 from separating from the water or other liquid components of the food product coating 106, preventing the food products 102 from weeping, becoming overly sticky or oily, or the like. In a further embodiment, the anhydrous mix 204 and the food product coating 106 are free or substantially free of milk and/or dairy products, such as milk, cream, butter, and the like, so that the food product coating 106 does not sour over time. The food product coating 106, once prepared from the anhydrous mix 204, in one embodiment, may have a shelf life of 7-8 days or more without refrigeration due to the included stabilizer and lack of milk and/or dairy products.

In the embodiment shown in FIG. 1, the system 100 includes a tray 104 that supports the food products 102 while an end user, either directly or through a machine, applies the food product coating 106 to the food products 102 from a container 108. In the depicted embodiment, the end user pours the food product coating 106 from the container 108 over the food products 102 to apply the food product coating 106 to the food products 102. In other embodiments, an end user may dip the food products 102 in the food product coating 106, may spray the food product coating 106 onto the food products 102, may spread the food product coating 106 onto the food products 102, or may otherwise place the food product coating 106 into contact with an outer surface of the food products 102 to apply the food product coating 106 to the food products 102. The food products 102 may include baked goods, fried goods, or other types of food products 102. The food products 102, in the depicted embodiment, comprise doughnuts, such as yeast raised doughnuts, cake doughnuts, or the like. In other embodiments, the food products 102 may comprise one or more of a doughnut, a pastry, a cake, a roll (e.g. a cinnamon roll, an orange roll), a confection, a bread, a pie, a fritter, a strudel, a Bismarck, a cookie, a beignet, a kolache, or the like.

In the depicted embodiment, an end user pours the food product coating 106 from the container 108 over the food products 102 in a sheet or stream that coats the food products 102 as the end user passes the container 108 over the tray 104. Excess food product coating 106 passes through openings in the tray 104 into another container (not shown) that collects the excess food product coating 106 for re-use. In certain embodiments, the end user may make multiple passes over the food products 102 with the container 108 of the food product coating 106 until the food product coating 106 coats the food products 102 with a desired thickness or amount.

The food product coating 106, in one embodiment, has a limited shelf life, such as a shelf life of about 7-8 days or the like, even without refrigeration, depending on ingredients and storage environment. The anhydrous mix 204, however, may have a shelf life of multiple years. For example, the anhydrous mix 204 may have a shelf life of about 5-10 years or more, depending on ingredients, packaging, storage environment, and the like. The lighter weight of the anhydrous mix 204 and the greater shelf life of the anhydrous mix 204, in comparison to the food product coating 106, makes shipment, storage, and use of the anhydrous mix 204 more labor and cost efficient for vendors, manufacturers, and end users than that of pre-prepared food product coating 106.

FIG. 2 depicts one embodiment of a sectional cutaway view 200 of an anhydrous mix 204 for a food product coating 106. In the depicted embodiment, the anhydrous mix 204 is disposed in a container 202 with a lid 206 and a handle 208. The container 202, in the depicted embodiment, is a bucket, such as a 5 gallon bucket or the like. The lid 206 seals the container 202 from materials exterior to the container 202, such as moisture or the like, to prolong the shelf life of the anhydrous mix 204. The handle 208 facilitates transportation of the container 202 of anhydrous mix 204, allowing users to carry the container 202 by the handle 208.

The anhydrous mix 204 is a composition of matter comprising a dry or substantially dry solid mixture containing a plurality of ingredients. In one embodiment, the anhydrous mix 204 includes one or more anhydrous sweeteners, such as sugar (e.g. powdered sugar, granulated sugar), anhydrous glucose syrup (e.g. corn syrup; glucose syrup from potatoes, wheat, barley, and/or rice), or the like. The anhydrous mix 204, in one embodiment, comprises between about 97% and 99.9% anhydrous sweeteners, by weight. In a further embodiment, the anhydrous mix 204 comprises about 99.8% anhydrous sweeteners, by weight.

In certain embodiments, the anhydrous mix 204 includes powdered sugar. Powdered sugar, in one embodiment, is the predominant ingredient of the anhydrous mix 204. The powdered sugar of the anhydrous mix 204, in certain embodiments, has a granularity between 6× and 14× (where higher numbers refer to finer granularity as is known in the art). In a further embodiment, the powdered sugar of the anhydrous mix 204 has a granularity of 6×. Using a fine grade of powdered sugar, such as powdered sugar with a granularity between 6× and 14×, in certain embodiments, allows the powdered sugar to quickly and easily dissolve when preparing the food product coating 106 so that the food product coating 106 is not grainy or coarse. The anhydrous mix 204, in one embodiment, comprises between about 97% and 99.9% powdered sugar, by weight. In a further embodiment, the anhydrous mix 204 comprises about 98.1% powdered sugar, by weight. In another embodiment, instead of or in addition to powdered sugar, the anhydrous mix 204 may include granulated sugar or another type of sugar.

The anhydrous mix 204, in one embodiment, includes an anhydrous glucose syrup, such as corn syrup or a syrup made from hydrolysis of another starch, such as potatoes, wheat, barley, rice, or the like. The anhydrous glucose syrup may be dehydrated, dry or substantially dry, and may comprise exclusively glucose syrup solids. For example, the anhydrous glucose syrup may comprise dehydrated, dried, powdered, and/or granulated corn syrup solids, or the like. Including an anhydrous glucose syrup in the anhydrous mix 204, in addition to a sugar, may enhance sweetness of the food product coating 106, soften a texture of the food product coating 106, add volume to the food product coating 106, help prevent crystallization of sugar in the food product coating 106, or the like. The anhydrous glucose syrup of the anhydrous mix 204, in one embodiment, has a dextrose equivalent (“DE”) between about 24 DE and 42 DE. In a further embodiment, the anhydrous glucose syrup has a dextrose equivalent of about 36 DE. The anhydrous mix 204, in one embodiment, comprises between about 0.5% and 3% anhydrous glucose syrup, by weight. In a further embodiment, the anhydrous mix 204 comprises about 1.7% anhydrous glucose syrup, by weight.

In one embodiment, the anhydrous mix 204 includes an anhydrous stabilizer that inhibits separation of components of the food product coating 106, such as ingredients of the anhydrous mix 204, water, or the like. Including a stabilizer in the anhydrous mix 204 may extend the shelf life of the food product coating 106 and of the food products 102 to which the food product coating 106 is applied. For example, a stabilizer may inhibit sugars or other ingredients from the anhydrous mix 204 from separating from the water or other liquid components of the food product coating 106, preventing the food products 102 from weeping, becoming overly sticky or oily, or the like. The stabilizer of the anhydrous mix 204 may comprise an emulsifier, a surfactant, a gelling agent, or the like. For example, the stabilizer, in various embodiments, may comprise one or more of agar, gum guar, locust bean gum, gelatin, pectin, a carrageenan, a lecithin, a lactylate, and/or other stabilizers.

Conventionally, to function properly, a stabilizer is pre-hydrated in water (usually boiling water) before use. For this reason, stabilizers have traditionally been left out of conventional food product coatings, or, if stabilizers are included, preparation of food product coatings with stabilizers has been a complicated multi-step process of first hydrating the stabilizer and then adding other ingredients as separate steps. However, in certain embodiments, the anhydrous mix 204 includes an anhydrous, fine-grained, powder stabilizer, selected to hydrate even when added to water in a single step with the other components of the anhydrous mix 204, without pre-hydration.

For example, as described in greater detail below with regard to FIGS. 3A and 3B, agar (and other types of stabilizers) is typically distributed in blocks, strips, or pasty clumps, each of which require pre-hydrating before use. The anhydrous mix 204, in one embodiment, includes an anhydrous, fine-grained, agar powder that acts as a stabilizer for the food product coating 106 without pre-hydration, allowing the anhydrous mix 204 to be mixed with water in a single step, without a separate pre-hydration step. In one embodiment, the agar powder may have a particle size or grain size (diameter) of between about 0.05 millimeters and 1 millimeter. In another embodiment, the agar powder may have a particle size of less than about 0.25 millimeters. In a further embodiment, the agar powder may have a particle size of less than about 0.1 millimeters. In contrast with the anhydrous, fine-grained, agar powder described herein, pasty clumps of agar may have particle sizes of 1.5 millimeters or more, and agar blocks and strips may be orders of magnitude larger than that.

In certain embodiments, the anhydrous mix 204 may include substantially less stabilizer by weight as a result of using an anhydrous, fine-grained, powder stabilizer such as the agar powder described above than would be necessary if using stabilizers of larger particle sizes, such as blocks, strips, or pasty clumps, without a corresponding loss in stabilization. For example, where 6 ounces of conventional agar (in blocks, strips, or pasty clumps) may be necessary for 100 pounds of powdered sugar, in one embodiment, the anhydrous mix 204 includes 1 ounce of anhydrous, fine-grained, agar powder to achieve a substantially similar stabilizing effect. In one embodiment, the anhydrous mix 204 may include between about 0.025% and 0.4% anhydrous stabilizer, by weight. In a further embodiment, the anhydrous mix 204 may include about 0.06% anhydrous stabilizer, by weight. An anhydrous, fine-grained, powder stabilizer, in one embodiment, may have a substantially similar stabilizer concentration to stabilizers with larger particle sizes (e.g. stabilizer bars, strips, pasty clumps). In another embodiment, an anhydrous, fine-grained, powder stabilizer may have a greater stabilizer concentration than stabilizers with larger particle sizes, or the like.

The anhydrous mix 204, in certain embodiments, may include salt. A small amount of salt may be substantially imperceptible to the taste in the food product coating 106, but may bring out the flavor of the food product coating 106 by opening up the taste buds of the taster, or the like. In one embodiment, the anhydrous mix 204 may include between about 0.001% salt and 0.01% salt, by weight. In a further embodiment, the anhydrous mix 204 may include about 0.003% salt, by weight. The salt, in certain embodiments, is a fine-grained powder salt with a smaller particle size than table salt.

In certain embodiments, the anhydrous mix 204 may include one or more anhydrous flavorings. Anhydrous flavorings may include powdered vanilla flavoring, powdered chocolate flavoring, powdered maple flavoring, powdered fruit flavoring, or the like. The anhydrous mix 204, in one embodiment, includes between about 0.05% and 0.15% anhydrous flavoring, by weight. In a further embodiment, the anhydrous mix 204 includes about 0.09% anhydrous flavoring by weight. In another embodiment, the anhydrous mix 204 may include one or more anhydrous coloring agents, to give the food product coating 106 a desired color, to make the food product coating 106 opaque, or the like.

In certain embodiments, the ingredients of the anhydrous mix 204, such as powdered sugar, anhydrous glucose/corn syrup, anhydrous stabilizer, salt, anhydrous flavoring, and/or anhydrous coloring agent, are distributed substantially evenly throughout the anhydrous mix 204 in the container 202. In the depicted embodiment, the anhydrous mix 204 fills half or less of the container 202 and the container 202 includes an available space 210. The available space 210, in one embodiment, is sized so that the food product coating 106, when prepared from the anhydrous mix 204 in the container 202, will fit within the container 202. In this manner, the same container 202 that stores the anhydrous mix 204 may be reused to store the food product coating 106 prepared from the anhydrous mix 204. For example, in an embodiment where the container 202 comprises a 5 gallon bucket, an end user may mix the anhydrous mix 204 with about 3 gallons of water to prepare the food product coating 106, and the anhydrous mix 204 and the about 3 gallons of water, combined to form the food product coating 106, may fit within the 5 gallon bucket.

In one embodiment, an end user heats and/or boils water in a separate container, adds the anhydrous mix 204 from the container 202 into the separate container, and mixes or beats the anhydrous mix 204 and the water for a predefined period of time or until smooth, such as 8 to 10 minutes or the like, to form the food product coating 106. Once the end user has formed the food product coating 106, in one embodiment, the end user may pour the food product coating 106 into the original container 202 (or another container) for storage. In another embodiment, an end user may add heated and/or boiling water directly into the container 202 of anhydrous mix 204, and mix or beat the anhydrous mix 204 and the water directly in the container 202 to form the food product coating 106, which may remain in the container 202 for storage, be transferred to another container, or the like.

In one example embodiment, for illustration purposes, the anhydrous mix 204 may comprise about 1 quart of anhydrous corn syrup (about 1.7172% of the anhydrous mix 204, by weight); about 1 ounce of anhydrous, fine-grained, agar powder stabilizer (about 0.0613% of the anhydrous mix 204, by weight); about 100 pounds of powdered sugar (about 98.1264% of the anhydrous mix 204, by weight); ⅓ cup anhydrous flavoring such as powdered vanilla (about 0.09199% of the anhydrous mix 204, by weight); and ¼ teaspoon powdered salt (about 0.003066% of the anhydrous mix 204, by weight). The example embodiment yields about 19 gallons of food product coating. In other words, it yields enough anhydrous mix 204 to fill, when mixed with water, about 3.8 five-gallon buckets, with an end user mixing anhydrous mix in each five-gallon bucket with 3 gallons of water, which may be heated and/or boiling as described above, to form about 5 gallons of the food product coating 106 per five gallon bucket, for three buckets, and about 4 gallons of the food product coating 106 for the fourth bucket.

FIG. 3A depicts one embodiment of stabilizers 300. The stabilizers 300 include a clump of stabilizer paste 302 and a granule of anhydrous, fine-grained, stabilizer powder 304. As described above, a stabilizer 300 may comprise an emulsifier, a surfactant, a gelling agent, or the like such as agar, gum guar, locust bean gum, gelatin, pectin, a carrageenan, a lecithin, a lactylate, or other stabilizers.

The clump of stabilizer paste 302, in one embodiment, must be pre-hydrated in water before use, creating at least one extra step if the clump of stabilizer paste 302 is to be used for a food product coating when compared to the granule of stabilizer powder 304, which may be fully hydrated simultaneously with adding the rest of the anhydrous mix 204 to water as described above. In one embodiment, the anhydrous mix 204 comprises a plurality of granules of anhydrous, fine-grained, stabilizer powder 304 that hydrate even when added to water in a single step with other components of the anhydrous mix 204, without pre-hydration.

In one embodiment, the granule of stabilizer powder 304 may have a particle size or grain size (diameter) of between about 0.05 millimeters and 1 millimeter. In another embodiment, the granule of stabilizer powder 304 may have a particle size of less than about 0.25 millimeters. In a further embodiment, the granule of stabilizer powder 304 may have a particle size of less than about 0.1 millimeters. In contrast with the granule of stabilizer powder 304, the clump of stabilizer paste 302, in one embodiment, may have a particle size of 1.5 millimeters or more, and stabilizer blocks and strips may be orders of magnitude larger than that.

FIG. 3B depicts another embodiment of stabilizers 310. The stabilizers 310 include a group of clumps of stabilizer paste 312 and a group of granules of anhydrous, fine-grained, stabilizer powder 314. The stabilizers 310 may comprise agar or another type of stabilizer as described above. In the depicted embodiment, the group of clumps of stabilizer paste 312 is larger, by weight, than the group of granules of anhydrous, fine-grained, stabilizer powder 314. In one embodiment, the group of clumps of stabilizer paste 312 is about 6 times larger, by weight, than the group of granules of anhydrous, fine-grained, stabilizer powder 314. For example, the group of clumps of stabilizer paste 312 may weigh 6 ounces and the group of granules of anhydrous, fine-grained, stabilizer powder 314 may weigh 1 ounce, or the like.

In certain embodiments, despite the difference in weight, the group of clumps of stabilizer paste 312 and the group of granules of anhydrous, fine-grained, stabilizer powder 314 each have substantially the same stabilizing efficacy and achieve a substantially similar stabilizing effect in similar amounts of food product coating 106. It is unknown exactly why this is. The group of anhydrous, fine-grained, stabilizer powder granules 314, in one embodiment, may have a substantially similar stabilizer concentration as the group of clumps of stabilizer paste 312 but a higher efficacy per weight than the group of clumps of stabilizer paste 312 due to the difference in particle size, or the like. In another embodiment, the group of anhydrous, fine-grained, stabilizer powder 314 may have a greater stabilizer concentration than the group of clumps of stabilizer paste 312, or the like.

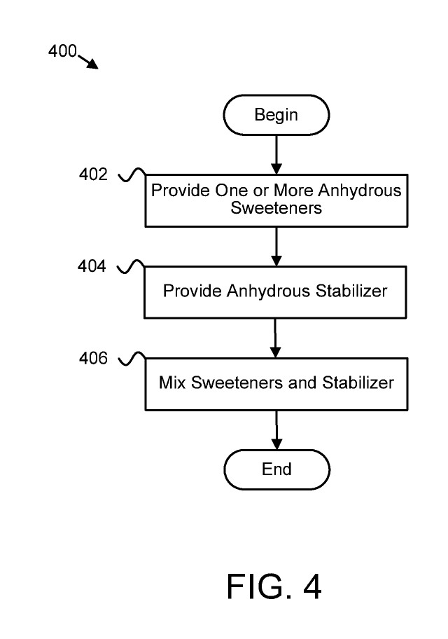

FIG. 4 depicts one embodiment of a method 400 for preparing an anhydrous mix 204 for a food product coating 106. In one embodiment, the method 400 is performed by a preparer. A preparer may comprise one or more end users, manufacturers, distributers, vendors, bakers, employees, automated electrical and/or mechanical devices, or the like. The method 400 begins and a preparer provides 402 one or more anhydrous sweeteners, adding the one or more anhydrous sweeteners to a container or the like. The preparer provides 404 an anhydrous stabilizer, adding the anhydrous stabilizer to the container or the like. The preparer mixes 406 the one or more anhydrous sweeteners and the anhydrous stabilizer to form an anhydrous mix 204 for a food product coating 106 and the method 400 ends.

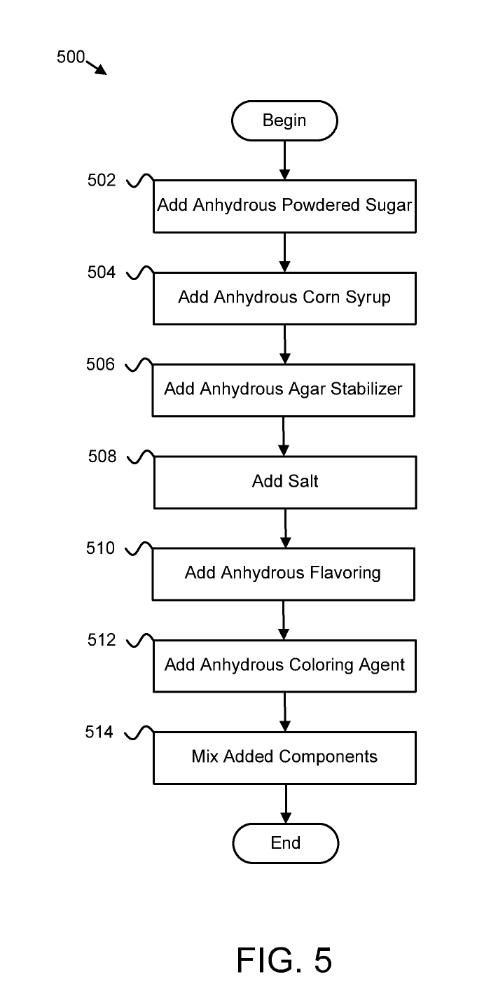

FIG. 5 depicts another embodiment of a method 500 for preparing an anhydrous mix 204 for a food product coating 106. The method 500 begins and a preparer adds 502 anhydrous powdered sugar to a container. The preparer adds 504 anhydrous corn syrup to the container. The preparer adds 506 an anhydrous agar stabilizer to the container. The preparer adds 508 salt to the container. The preparer adds 510 anhydrous flavoring to the container. The preparer adds 512 an anhydrous coloring agent to the container. The preparer mixes 514 the added anhydrous powdered sugar, corn syrup, agar stabilizer, salt, flavoring, and coloring agent in the container to form an anhydrous mix 204 for a food product coating 106 and the method 500 ends.

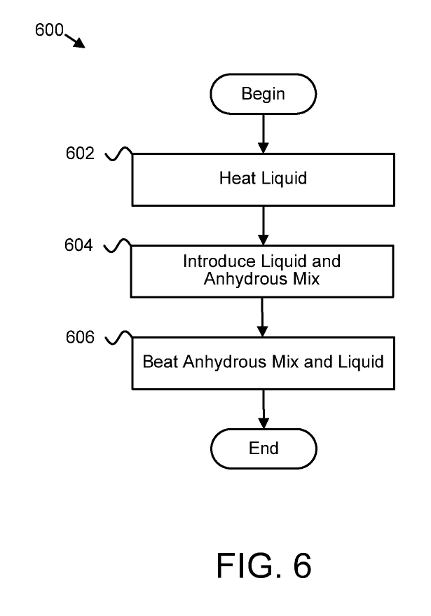

FIG. 6 depicts one embodiment of a method 600 for preparing a food product coating 106 from an anhydrous mix 204. The method 600 begins and a preparer heats 602 water or another liquid, to a predefined temperature, to a boil, or the like. In other embodiments, instead of heating 602 the water, the preparer may use cold water, room temperature water, another liquid, or the like, depending on the types and amounts of stabilizers, anhydrous sweeteners, or other ingredients in the anhydrous mix 204. The preparer introduces 604 the water and the anhydrous mix 204 or other liquid uniformly in a single step, adding the liquid to the anhydrous mix 204, adding the anhydrous mix 204 to the liquid, or the like. The preparer beats 606 or otherwise mixes the anhydrous mix 204 and the water or other liquid to form a food product coating 106 and the method 600 ends.

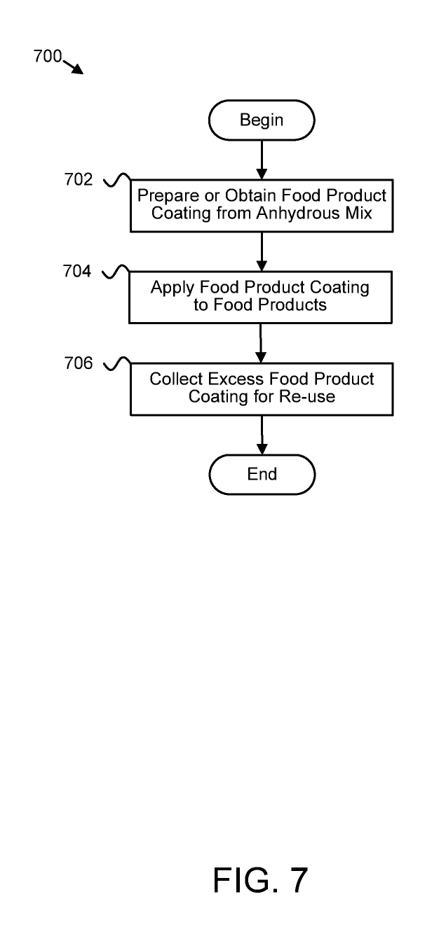

FIG. 7 depicts one embodiment of a method 700 for applying a food product coating 106 prepared from an anhydrous mix 204 to food products 102. The method 700 begins, a preparer prepares 702 food product coating 106 from an anhydrous mix 204, or obtains 702 food product coating 106 so prepared, applies 704 the food product coating 106 to exterior surfaces of one or more food products 102, collects 706 excess food product coating 106 for re-use (e.g., to re-apply the collected 706 excess food product coating 106 to the one or more food products 102 or to other food products 102), and the method 700 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for an anhydrous mix for a food product coating, the method comprising:
providing one or more anhydrous sweeteners;
providing an anhydrous stabilizer; and
mixing the one or more anhydrous sweeteners and the anhydrous stabilizer to form an anhydrous mix for a food product coating.

2. The method of claim 1, further comprising adding the anhydrous mix to a liquid in a single step without pre-hydration of the anhydrous stabilizer.

3. The method of claim 1, further comprising packaging the anhydrous mix in a container such than an available space remaining in the container is sized to receive a liquid added to the anhydrous mix to form the food product coating within the container.

4. The method of claim 1, further comprising mixing one or more of an anhydrous salt, an anhydrous flavoring, and an anhydrous coloring agent with the one or more anhydrous sweeteners and the anhydrous stabilizer.

5. The method of claim 1, wherein the anhydrous stabilizer is configured to inhibit the one or more anhydrous sweeteners from separating from a liquid when mixed with the liquid.

6. The method of claim 1, wherein the anhydrous stabilizer comprises an anhydrous agar powder.

7. The method of claim 1, wherein the anhydrous stabilizer has a particle size of less than 0.25 millimeters.

8. The method of claim 7, wherein the anhydrous stabilizer has a particle size of less than 0.1 millimeters.

9. The method of claim 1, wherein the anhydrous stabilizer comprises less than 0.2% of the anhydrous mix, by weight.

10. The method of claim 1, wherein the anhydrous stabilizer comprises less than 0.1% of the anhydrous mix, by weight.

11. The method of claim 1, wherein the one or more anhydrous sweeteners comprise an anhydrous powdered sugar.

12. The method of claim 11, wherein the one or more anhydrous sweeteners further comprise an anhydrous glucose syrup powder.

13. The method of claim 1, wherein the anhydrous mix is free of dairy products.

14. A method for an anhydrous mix for a food product coating, the method comprising:
heating a liquid;
introducing the liquid and an anhydrous mix, the anhydrous mix comprising one or more anhydrous sweeteners and an anhydrous stabilizer, the liquid and the anhydrous mix introduced without pre-hydration of the anhydrous stabilizer; and
mixing the anhydrous mix and the liquid to form a food product coating.

15. The method of claim 14, further comprising applying the food product coating to one or more food products.

16. The method of claim 14, wherein the anhydrous stabilizer is configured to inhibit the one or more anhydrous sweeteners from separating from the liquid in the food product coating.

17. The method of claim 14, wherein the anhydrous stabilizer comprises a fine-grained anhydrous agar powder.

18. An anhydrous mix for a food product coating, the anhydrous mix comprising:
one or more anhydrous sweeteners; and
an anhydrous stabilizer configured to inhibit the one or more anhydrous sweeteners from separating with a liquid when mixed with the liquid.

19. The anhydrous mix of claim 18, further comprising one or more of an anhydrous salt, an anhydrous flavoring, and an anhydrous coloring agent with the one or more anhydrous sweeteners and the anhydrous stabilizer.

20. The anhydrous mix of claim 18, wherein the anhydrous stabilizer comprises an anhydrous agar powder having a particle size of less than 0.1 millimeters.

21. The anhydrous mix of claim 20, wherein the anhydrous stabilizer comprises less than 0.1% of the anhydrous mix, by weight.
